(19) United States
(12) Patent Application Publication
(10) Pub. No.: US 2009/0186153 A1
(43) Pub. Date: Jul. 23, 2009

(54) PROCESS FOR SYNTHESISING COATED ORGANIC OR INORGANIC PARTICLES

(75) Inventors: Audrey Hertz, Beziers (FR); Bruno Fournel, Venejan (FR); Christian Guizard, Cournonterral (FR); Anne Julbe, Montpellier (FR); Jean-Christophe Ruiz, Laudun (FR); Stephane Sarrade, Montpellier (FR)

Correspondence Address: Nixon Peabody LLP, 200 Page Mill Road, Palo Alto, CA, 94306, US

(73) Assignees: Commissariat A L"energie Atomique, Paris (FR); Centre National De La Recherche Scientifique, Paris (FR); Universite Montpellier 2, Montpellier (FR)

(21) Appl. No.: 12/300,785

(22) PCT Filed: May 14, 2007
(86) PCT No.: PCT/EP2007/054648

§ 371 Date: Nov. 13, 2008

(30) Foreign Application Priority Data
May 15, 2006 (FR) 06 51734

(51) Int. Cl. B05D 7/00

(52) U.S. Cl. 427/216; 427/212

(57) ABSTRACT

A process for the “in situ” manufacture, in a pressurized CO₂ medium, of coated particles. The manufacturing process is characterized in that the steps of synthesising the particles and of coating these particles are coupled in such a way that the synthesised particles remain dispersed in a pressurized CO₂ medium at least until the coating. The device comprises a reactor for synthesising particles in a pressurized CO₂ medium; a means of injecting the coating material or precursor thereof into said reactor; a means of supplying said reactor with a pressurized CO₂ medium; in which the means of injecting the coating material or precursor thereof is coupled to the synthesis reactor in such a way that the injection of the coating material or precursor thereof into said reactor does not destroy the dispersion of the particles, in a pressurized CO₂ medium, in said reactor.

### CROSS REFERENCE TO RELATED APPLICATIONS

This application is a national phase of International Application No. PCT/EP2007/054648, entitled “METHOD OF SYNTHESISING COATED ORGANIC OR INORGANIC PARTICLES”, which was filed on May 14, 2007, and which claims priority of French Patent Application No. 06 51734, filed May 15, 2006.

### DESCRIPTION

1. Technical Field

The present invention relates to a process for the “in-situ” synthesis, in a pressurized, for example supercritical, CO₂ medium, of coated organic or inorganic particles.

According to the present invention, the particles to be coated are synthesised and then coated using a single process, in a single device, hence the expression “in situ”. In other words, the synthesis and the coating of particles can be carried out in a single operation.

The process of the present invention makes it possible to produce the coated particles continuously, semi-continuously or batchwise. The particles to be coated are generally in the form of a powder.

The present invention has a very large number of industrial applications, for example in the manufacture of ion conductors, catalysts, ceramics, coatings, cosmetic products, pharmaceutical products, etc. These applications will be described in greater detail hereinafter.

By way of example, the process of the present invention allows the synthesis of nanophase oxides and coating of the latter with various coating agents.

In the present description, the references between square brackets ([.]) refer back to the list of references located after the examples.

2. Prior Art

Since the 1990s, research into techniques for synthesising materials in a pressurized, in particular supercritical, medium has been in full expansion. Various types of materials can be synthesised by these techniques: organic materials, for example polymer materials, or inorganic materials, for example metallic or ceramic materials. Various synthesis media have been and are currently being studied, such as supercritical alcohols, supercritical water and supercritical CO₂.

Semi-continuous and continuous processes for synthesising oxide particles in a supercritical CO₂ medium have already been described in the literature. These processes are based on two types of reactions: a sol-gel reaction and thermal decomposition of precursors.

Similarly, processes for coating in a supercritical medium are the subject of many publications. Supercritical pharmaceutical processes often combine the formulating of active ingredients (particles to be coated) and the encapsulation thereof.

Some reminders of the literature are mentioned below by way of example, first for the synthesis of oxide particles, then for the coating of particles.

In the case of ceramic particles, one of the main processes for synthesising ceramic oxide currently used is the sol-gel process. For example, Subramanian et al., in 2001 [1], describe the synthesis of yttrium oxide by the sol-gel process. Also for example, Znaidi et al. [2] describe a semi-continuous process for the synthesis of magnesium oxide powders by the sol-gel process.

Adshiri et at. [3] have described a hydrothermal crystallization process for the rapid and continuous synthesis of metal oxide particles in supercritical water. This is a continuous synthesis process, using a hydrothermal process. Furthermore, a homogeneous oxidizing or reducing atmosphere can be created by introducing gases or additives (for example, O₂, H₂, H₂O₂) so as to bring about new reactions and the formation of new compounds [4]. Some recent examples of hydrothermal synthesis may be mentioned, such as the continuous reaction in supercritical water for La₂CuO₄ synthesis described in 2000 [5] or the synthesis of nanocrystalline particles of zirconium oxide and of titanium oxide described in 2002 by Kolen'ko et al. [6]. In 2002, Viswanathan et al. described the continuous formation, in a tube reactor, of zinc oxide nanoparticles by oxidation of zinc acetate in a supercritical water medium [7]. A preheated aqueous solution of hydrogen peroxide is used as oxidizing agent.

Tests combining the thermal decomposition of an alkoxide as organometallic precursor and the use of a supercritical solvent were carried out in the 1990s, and the supercritical solvents used during these tests were supercritical alcohols, such as ethanol or methanol. The mechanism used in this method is a complex mechanism generally involving hydrolysis, polycondensation and thermal decomposition reactions [8]. TiO₂ [9] or Mg₂Al₂O_{4 [}8, 10] and MgO [11] powders have in particular been obtained in supercritical alcohol alone or as a mixture in supercritical CO₂.

Supercritical solvents, in particular alcohols and CO₂, were used for the sol-gel process, firstly, at the time of the gel drying step, in order to eliminate the residual solvent after the reaction. A semi-continuous process was developed for the synthesis of nanometric metal oxide powders (chromium oxide, magnesium oxide, barium titanate). The synthesis of titanium dioxide nanopowders by such a process was described in 2001 by Znaidi et al. [12].

Supercritical solvents were subsequently used directly as reaction solvent in a process similar to the sol-gel process. This involves, for example, the thermal decompositions of alkoxides previously described and which can be considered to be something approaching a sol-gel reaction [8].

In 1997, a process for preparing aerogels using supercritical CO₂ as solvent for the sol-gel polymerization of alkoxysilanes was described by Loy et alo [13]. Supercritical CO₂ coupled with a process of sol-gel type was the subject of a patent application in 1998 [14] relating to the synthesis of particles of single oxides, in particular of SiO₂ and TiO₂, or of mixed oxides. These studies were subsequently developed in the course of two theses. The first was produced by S. Papet [15] and was defended in 2000. It related to the synthesis of titanium oxide particles by hydrolysis of an organometallic precursor, titanium tetraisopropoxide, for membrane applications in tangential filtration. The second thesis was produced by O. Robbe [16] and was defended in 2003. It related to the synthesis of ion-conducting mixed oxide particles (doped ceria, doped lanthanum and gallate oxides, doped zirconium oxide) for applications in particular as electrolytes in solid oxide fuel cells (SOFC).

In 2002, Reverchon et al. [17] proposed a system for the continuous synthesis of titanium hydroxide particles by means of a titanium tetraisopropoxide hydrolysis reaction in supercritical CO₂ medium.

As regards the coating of particles, the coating processes have been the subject of numerous research studies and publications. These processes are generally based on coating processes via the conventional chemical route or coating processes in a supercritical medium.

Among the processes via the chemical route, mention may, by way of example, be made of interfacial polycondensation processes, emulsion polymerization and polymerization in a dispersed medium, which are among the chemical processes commonly used for coating a polymer. Emulsion polymerization of methyl methacrylate (MMA), in an aqueous solution of sodium dodecyl sulphate (SDS), for coating titanium dioxide particles, has in particular been described by Caris et al. [18]. Similarly, synthesis of zinc oxide/poly(methyl methacrylate) composite microspheres by suspension polymerization was described by Shim et al. [19] in 2002.

Among the coating processes in a supercritical CO2 medium, mention may, for example, be made of the processes described by J. Richard et al. [20] and by Jung et al. [21]. Mention may also be made, for example, of the processes by rapid expansion of supercritical solutions (RESS) as described by J-H. Kim et al. [22] or derived methods such as those described by Y. Wang et al. [23]; the RESS-N process (RESS with a non-solvent) [24, 25]; the RESS process in a fluidized bed [26, 27]; gas antisolvent (GAS) processes or supercritical antisolvent processes (SAS for “Supercritical AntiSolvent” or “Supercritical Fluid AntiSolvent”) [28, 29]; the phase separation process (used in a batch reactor) [30]; and polymerization in a dispersed medium [31].

Coating by the RESS process is based on the rapid expansion of supercritical solutions containing the coating agent and the particles to be coated. This process has been used in particular by Kim et al. [22] for the microencapsulation of Naproxen. Another process uses the RESS process for spraying the coating agent (dissolved in the CO₂) onto the particles. This process has, for example, been used by Chernyak et al. [32] for the formation of a perfluoroether coating for porous materials (applications in civil infrastructures and monuments) and by Wang et al. [23] for coating glass beads with polyvinyl chloride-co-vinyl acetate (PVCVA) and hydroxypropylcellulose (HPC).

The RESS process with a non-solvent is a modified RESS process: it enables the encapsulation of particles that are weakly soluble in supercritical CO₂, with a coating agent that is insoluble in supercritical CO₂. The coating agent is solubilized in a CO₂/organic solvent mixture, the particles to be coated are dispersed in this medium. The depressurization of this dispersion brings about the precipitation of the coating agent on the particles. This process has been used for the formation of microcapsules of medicines [24], the microencapsulation of protein particles [25] and the coating of oxide particles (TiO₂ and SiO₂) with polymers [33, 34].

The coupling of the RESS process and a fluidized bed has also been developed: the particles to be coated are fluidized by a supercritical fluid or gas, and the coating agent solubilized by the supercritical CO₂ is precipitated at the surface of the fluidized particles [26, 27, 35].

For the antisolvent processes, applied to the coating of particles [21], the particles and the coating agent are dissolved or suspended in an organic solvent, and then sprayed, together or separately, in the antisolvent consisting of the supercritical CO₂. Multipassage nozzles are used to allow the spraying of the various components, in particular for the ASES process and the SEDS process.

Juppo et al. [36] have described the incorporation of active substances (particles to be coated) in a matrix (coating agent) using supercritical antisolvent processes. The semi-continuous SAS process has been used by Elvassore et al. [28] for the production of protein-loaded polymeric microcapsules. The ASES process used for the preparation of microparticles containing active ingredients has been described by Bleich et al. [29].

It is possible to form microspheres via the PGSS process by saturating a solution of the particles in the coating agent, with supercritical CO₂ before rapidly expanding it. The advantage of this process is that it is not necessary for the particles and the coating agent to be soluble in the supercritical CO₂ [21]. Shine and Gelb have described liquefaction of a polymer using supercritical solvation for the formation of microcapsules [37].

The phase-separation coating technique is very suitable for an apparatus operating in the batch mode [30]. This process was described for coating proteins with a polymer by Ribeiros Dos Santos et al. [30] in 2002. A slightly different process was used by Glebov et al. [38] 2001 for coating metal particles. Two units are used: the first containing the coating agent (it enables it to be solubilized in supercritical CO₂) and the second containing the metal particles. The two units are connected to one another by a valve so as to allow transfer of the solubilized coating agent.

The process by polymerization in a dispersed medium consists in carrying out the polymerization in supercritical CO₂ medium, on the surface of the particles to be coated. The principle is the same as for coating by conventional polymerization. For this process, the use of a surfactant suitable for supercritical CO₂ is essential, in order to allow the dispersion of the particles to be coated and the attachment of the polymer to the surface of the particles. Descriptions of coating via this process are beginning to appear in the literature. Yue et al. [31] thus coated micrometric organic particles with PMMA and PVP. The same team [39] described, on a poster on the occasion of the 227^{th} national ACS meeting in Anaheim in April 2004, the PMMA-coating of particles of silica synthesised in a supercritical medium.

Supercritical processes, generally in the pharmaceutical field, combine the formulating of active ingredients, in the form of particles to be coated, and the encapsulation thereof. These processes are based on the solubilization of an active ingredient in the form of particles, and of the coating agent, followed by their precipitation in the supercritical medium by means of RESS or SAS processes.

However, no publication relates to the synthesis of oxide particles directly followed by the coating of said particles, in a pressurized CO₂ medium, such as a supercritical medium, either by a batch process or by a semi-continuous or continuous process.

These various prior art processes do not therefore make it possible to synthesise oxide particles coated “in situ”.

No process currently exists for the standardized production of oxide nanopowders in a pressurized CO₂ medium.

### DESCRIPTION OF THE INVENTION

The present invention provides a process for synthesising oxide particles coated “in situ”.

The present invention enables the synthesis and the coating of particles according to a standardized production, thereby facilitating industrialization thereof.

The present invention also enables a real improvement from the point of view of the handling of nanometric powders, of the stabilization of said powders with a view to the storage thereof, and also of the possible formulating thereof, for example by dispersion, pressing and then sintering, compared with the prior art processes.

The present invention may also make it possible to obtain powders which are functionalized, by virtue of the nature of their coating, which may have particular properties different from those of the powders.

The process for manufacturing particles coated with a coating material of the present invention comprises the following steps:
(a) synthesising particles in a pressurized CO₂ medium,
(b) bringing the synthesised particles and the coating material or the precursors of said material into contact, in a pressurized CO₂ medium,
(c) coating the synthesised particles with the coating material, using the coating material directly, or after conversion of the precursors of the coating material into said coating material, and
(d) recovering the coated particles,

steps (a) and (b) being coupled such that the particles synthesised in step (a) remain dispersed in a pressurized CO₂ medium at least until step (c).

This process can be carried out, for example, by means of devices which are described below.

The experimental tests have shown that the process of the invention is sound and rapid, and it makes it possible to control the quality and the amount of coated particles synthesised.

According to the invention, the expression “steps (a) and (b) being coupled” is intended to mean that step (b) is carried out without there being any interruption of the pressurized CO₂ medium following step (a). In other words, the particles synthesised remain in pressurized CO₂ medium until they are brought into contact with the coating material or its precursors in order for them to be coated. The result of this coupling is in particular that the synthesis and coating steps follow on from one another without there being any contact between the particles and the moisture in the air.

The difference between the prior art processes and that of the present invention is in particular this coupling. This coupling was not easy to implement given the specificity of each of the processes carried out, the desired quality of the coated particles, and the pressurized medium. The inventors of the present invention are the first to have carried out such a coupling which both works and gives very good quantitative and qualitative results for the manufacture of coated particles.

The process of the present invention also has the advantage that it enables batchwise, semi-continuous or continuous manufacture of coated particles, as illustrated by the examples below.

In the present invention, the term “coated particle” is intended to mean any chemical particle coated at its surface with a layer of a material different from that constituting the particle. These coated particles may constitute a powder, optionally in suspension or forming a deposit (for example, in the form of a thin film or of an impregnation). They may be used in various applications. They are found, for example, in ion conductors; catalysts; ceramics; surface coatings, for example for protection against corrosion, coatings for protection against wear, anti-friction coatings; cosmetic products; pharmaceutical products; etc.

The term “pressurized CO₂ medium” is intended to mean a gaseous CO₂ medium placed at a pressure above atmospheric pressure, for example at a pressure ranging from 2 to 74 bar, the CO₂ being in the form of a gas. This pressurized CO₂ medium may advantageously be a supercritical CO₂ medium, when the pressure is above 74 bar and the temperature is above 31° C.

Advantageously, according to the invention, step (a) of synthesising the particles may be carried out by any process known to those skilled in the art for manufacturing these particles in a pressurized CO₂ medium. The term “synthesis” according to step (a) is conventionally intended to mean any of the various steps constituting this phenomenon, for example primary nucleation, secondary nucleation, growth, maturation, heat treatment, etc. Use may, for example, be made of one of the synthesis protocols described in documents [8], [9], [10], [11], [12], [13], [14], [15], [16] and [17] of the attached list of references. The particles and the materials used for the manufacture of the particles may, for example, be those cited in these documents.

By way of nonlimiting examples, the particles which can be coated according to the invention may be chosen from metal particles; particles of metal oxide(s); ceramic particles; particles of a catalyst or of a mixture of catalysts; particles of a cosmetic product or of a mixture of cosmetic products; or particles of a pharmaceutical product or of a mixture of pharmaceutical products. By way of nonlimiting examples, the particles may be chosen from particles of titanium dioxide, of silica, of doped or undoped zirconium oxide, of doped or undoped ceria, of alumina, of doped or undoped lanthanum oxides, or of magnesium oxide.

According to the invention, the particles to be coated may be of all sizes. They may be a mixture of particles of identical or different size and/or of identical or different chemical nature. The size of the particles depends essentially on the process for manufacturing them. By way of example, with the abovementioned processes, the particles may have a diameter ranging from 30 nm to 3 μm. These particles may be agglomerated and may form clusters of several microns.

According to the invention, step (b) of bringing the synthesised particles into contact with the coating material or precursors thereof is carried out on the synthesised particles which are dispersed in a pressurized CO₂ medium.

According to a first embodiment of the process of the present invention, step (a) of synthesising the particles and step (b) of bringing said particles into contact with the coating material or precursors thereof are carried out in the same reactor, which is referred to below as “synthesising and contacting reactor”. This embodiment is suitable for semi-continuous or batch manufacture.

According to a second embodiment of the process of the invention, since step (a) of synthesising the particles is carried out in a first reactor, the synthesised particles are transferred, in a pressurized CO₂ medium, into a second reactor, step (b) of bringing said synthesised particles into contact with the coating material or precursors thereof being carried out in said second reactor. This transfer may be carried out, for example, continuously or semi-continuously.

Advantageously, according to the invention, step (a) of synthesising the particles may be followed by a step of sweeping the synthesised particles with pressurized CO₂ before carrying out step (b) of bringing said particles into contact with the coating material or precursors thereof. This sweeping step makes it possible to remove from the particles the possible excess and derivatives of the chemical products which have participated in the manufacture of said particles. This sweeping makes it possible to further improve the quality of the coated particles obtained according to the process of the present invention. According to the invention, irrespective of the embodiment, this step of sweeping the synthesised particles may be carried out in the reactor in which they were synthesised. In the second embodiment, it may also be carried out during the transfer of the synthesised particles from the first to the second reactor or in the second reactor.

According to the embodiment chosen, step (b) of bringing into contact preferably consists in injecting the coating material or precursors thereof into the reactor containing, in a pressurized CO₂ medium, the synthesised particles, or alternatively into the second reactor containing, in a pressurized CO₂ medium, the synthesised particles. Preferably, the coating material or precursors thereof is/are in a pressurized CO medium when it is (they are) injected. However, it/they may also be in an organic or inorganic medium as indicated below.

The inventors of the present invention also provide two variants of the second embodiment of the process of the invention. The term “variants” is intended to mean different examples of implementation of this second embodiment.

According to a first of these two variants, step (b) of bringing said synthesised particles into contact with the coating material or precursors thereof is carried out in said second reactor, this second reactor being a nozzle comprising a first and a second injection inlet, and also an outlet; in which the synthesised particles, in a pressurized CO₂ medium, are injected via the first inlet of the nozzle, and, at the same time as said particles, the coating material or precursors thereof is/are injected via the second inlet in such a way that the bringing into contact of the synthesised particles with the coating material or precursors thereof is carried out in said nozzle; and in which the coated particles or a mixture of particles and of coating material or precursors of said material is/are recovered via said outlet.

This first variant may be used, for example, for implementing the process of the invention using the SAS or RESS coating protocols, for example the SAS protocols described in documents [28, 29], or the RESS protocols described in documents [22] to [27].

According to a second of these two variants, step (b) of bringing said synthesised particles into contact with the coating material or precursors thereof is carried out in said second reactor this second reactor being a tube reactor comprising a first end equipped with an inlet and a second end equipped with an outlet; in which, on the one hand, in a pressurized CO₂ medium, the particles synthesised in the first reactor and, on the other hand, at the same time as said particles, the coating material or precursors thereof, are injected into said second reactor via the inlet in such a way that the bringing into contact of the synthesised particles with the coating material or precursors thereof is carried out in said second reactor; and in which the coated particles or a mixture of particles and of coating material or precursors of said material is/are recovered via said outlet.

Advantageously, the tube reactor mentioned above is a removable reactor, in order to be able to change the coils and to thus benefit from a reactor with a modulatable diameter and length and to be able to thus vary the residence time of the reactants in this reactor.

The second embodiment of the present invention corresponds to a process that is advantageous for continuous or semi-continuous manufacture. It uses two coupled systems: the first system being dedicated to the synthesis of the particles, the second system to the coating of the synthesised particles.

According to the invention, irrespective of the abovementioned embodiment, the coating material may be any of the coating materials known to those skilled in the art. It may, for example, be a material chosen from a sintering agent, a friction agent, an anti-wear agent, a plasticizer, a dispersant, a crosslinking agent, a metallizing agent, a metallic binder, an anti-corrosion agent, an anti-abrasion agent, a coating for a pharmaceutical product and a coating for a cosmetic product.

Documents [22] to [39] describe examples of coating materials that can be used for implementing the process of the present invention. By way of nonlimiting example, the coating material may be chosen from an organic polymer, a sugar, a polysaccharide, a metal, a metal alloy and a metal oxide.

By way of nonlimiting example, the coating material may be a polymer chosen from poly(methyl methacrylate) and polyethylene glycol; a metal chosen from copper, palladium and platinum; or a metal oxide chosen from magnesium oxide, alumina, doped or undoped zirconium oxide and doped or undoped ceria.

According to the invention, the “precursors of the coating material” generally consist of the chemical products that make it possible to obtain the coating material. For example, when the coating material is a polymer, the precursors thereof may be a monomer, a prepolymer of said polymer or a monomer/prepolymer mixture. For example, the precursors may also be a monomer, a prepolymer, an acetate, an alkoxide, and in addition to these products, additives, such as surfactants, polymerization initiators, reaction catalysts or acids. Documents [22] to [39] describe materials that are precursors of the coating material and that can be used in the present invention.

The process of the invention may also comprise a step (x) of preparing the coating material or precursors thereof before step (b) of bringing into contact. In the present text, the expression “preparing the coating material or precursors thereof” is intended to mean: synthesis of the coating material or precursors thereof or else solubilization of the coating material or precursors thereof. When a synthesis is involved, step (x) may be chosen, for example, from a sol-gel process, a polymerization process, a prepolymerization process, a thermal decomposition process and an organic or inorganic synthesis process. When a solubilization is involved, step (x) may consist in solubilizing the coating material in a solvent, which may be organic or inorganic (for example when an antisolvent (SAS) process is used), or in pressurized CO₂ medium, such as a supercritical CO₂ medium (for example when an RESS process is used). Documents referenced [22] to [39] on the list of references describe processes for preparing coating materials and suitable solvents that can be used in this step (x).

According to the invention, the coating of the particles in coating step (c) can be carried out, for example, by means of a process of precipitation of the coating material on said particles or by means of a process of chemical conversion of said precursors into said coating material in the presence of the particles to be coated.

Documents [22] to [39] describe coating processes that can be used in step (c) of the process of the present invention.

By way of example, when it is a precipitation process, it may be a process chosen from an antisolvent process, an atomization process in a supercritical medium and a phase separation process.

By way of example, when it is a process of chemical conversion of the coating material precursors into coating material, the process may be chosen from a polymerization, the coating material precursors being monomers and/or a prepolymer of the coating material in the presence of additives (such as surfactant and polymerization initiators); a sol-gel synthesis; a thermal decomposition process, and an inorganic synthesis process. The chemical conversion may be initiated by bringing the coating material precursor into contact with the particles as indicated above. Thus, according to the invention, coating step (c) may be carried out in the second reactor, subsequent to bringing the particles, in a pressurized CO₂ medium, into contact with the coating material or precursors thereof.

By way of example, according to the second embodiment of the process of the invention, step (c) of coating the particles may also be carried out at the outlet of said second reactor. This is the case, for example, for a coating carried out by precipitation according to an RESS process, in particular when the second reactor is a nozzle. Depressurization occurs at the outlet of the nozzle and brings about the precipitation of the coating material on the particles. An experimental exemplary embodiment is provided below.

Alternatively, according to the invention, it is possible to recover a mixture of particles and of coating material or precursors thereof at the outlet of the second reactor, it being possible for coating step (c) to be carried out in a reactor for recovering this mixture, connected to the outlet of said second reactor.

According to the invention, the coating may be a simple coating, i.e. a single layer of a single material, or a multiple coating, i.e. several layers of a single material or of several different materials (“multilayer” coating) or alternating layers of at least two different materials. Each layer may consist of a composite material prepared from a mixture of several materials. In order to obtain several layers of coating material, steps (b) and (c) of the method of the invention may be applied several times in succession, and, at each application, an identical or different coating material may be chosen. In this case, of course, in accordance with the present invention, the coated particles remain in a pressurized CO₂ medium until all the layers of coating material are deposited. Sweeping of the coated particles may be carried out before each new step (b) and (c), for example by means of pressurized CO₂, in order to clean the coated particles. The process of the present invention can therefore advantageously be adapted to all the possible configurations of coated particles desired.

According to the invention, the coating of the particles may be of any thickness necessary to obtain the desired coated particles. Generally, the thickness of the coating material may range up to a micrometre, but generally ranges from 0.1 to 5 nm.

The coated particles are subsequently recovered according to step (d) of the process of the invention. According to the invention, this recovery step may comprise sweeping of the coated particles with pressurized CO₂. This is because such a sweeping makes it possible to remove, from the coated particles obtained, the products and solvent in excess or which have not reacted. The coated particles obtained are thus “cleaned”. This sweeping of the coated particles may be carried out by simple injection of pure pressurized CO₂ into the reactor where they are recovered.

Irrespective of whether or not there is sweeping, step (d) of recovering the coated particles may comprise an expansion of the pressurized CO₂. This is the case, for example, when the coating has been carried out in a pressurized CO₂ medium. This expansion may, in certain cases, bring about the coating of the particles, as indicated above.

According to the invention, the coated particles may be recovered in a solvent or in a surfactant solution. This is the case, for example, when agglomeration of the coated particles with one another is undesirable in view of the use thereof in a subsequent process such as sintering or coating a surface. The solvent or the surfactant solution used depends on the chemical nature of the coated particles, and also on the use of these particles. The solvent may be organic or inorganic. It may be chosen, for example, from alcohols (such as ethanol, methanol or isopropanol), acetone, water and alkanes (pentane, hexane). The surfactant solution may be a solution of a surfactant chosen, for example, from dextran and Triton X. These particles thus suspended may be subsequently sprayed onto a support, for example a metal, glass or ceramic support, with a view to constituting a coating.

For the implementation of the first embodiment of the process of the invention, it is possible to use a device, hereinafter referred to as “first device”, comprising:
a reactor for synthesising the particles and for bringing the particles, in a pressurized CO₂ medium, into contact with the coating material or precursors thereof,
a means of feeding said reactor with particle precursor,
a means of injecting the coating material or precursors thereof into said reactor, and
a means of supplying said reactor with pressurized CO₂ medium,
valves placed between the reactor and the feed, injection and supply means,

in which the means of injecting the coating material or precursors thereof is coupled to the reactor in such a way that the injection of the coating material or precursors thereof into said reactor does not eliminate the pressurized CO₂ medium present in the reactor after synthesis of the particles.

The synthesis reactor may be any one of the reactors known to those skilled in the art for performing syntheses in a pressurized medium. It may be equipped with a stirrer spindle, and optionally baffles. These baffles break up the vortex created by the mechanical stirrer and improve the homogenization of the reaction medium for the synthesis of the particles and/or the coating of the particles.

The means of injecting the coating material therefore makes it possible to avoid any contact between the synthesised particles and the air, in particular during the introduction of the coating material or precursors thereof into the reactor. According to the invention, the injection means is preferably temperature-regulated (thermoregulated), preferably also pressure-regulated, this being the case in particular in order to have available all the parameters for controlling and maintaining a pressurized CO₂ medium in the reactor during the injection. Temperature and pressure ranges that can be envisaged may be, respectively, 100 to 700° C. and 10 to 500 bar.

The means of injecting the coating material may be connected to a means of supplying pressurized CO₂ medium. Thus, it is possible, by means of the pressurized CO₂, to keep the medium pressurized in the injection means, and, optionally to clean or flush the injection means. This supply means makes it possible, for example, to carry out RESS processes in the device of the invention.

In this first device, the means of injecting the coating material or precursors thereof may comprise a reactor for preparing the coating material or precursors thereof, said preparation reactor being connected to said injection means. For example, a tube may connect the reactor for preparing the coating material and the reactor for synthesising and contacting the particles, in a leaktight manner. A pump may enable the injection.

In order to prevent any clogging of the injection tube after the step of synthesising the particles in the synthesising and contacting reactor and to facilitate the intermediate cleaning of the system, two injection tubes may be used, one for injecting into the reactor the products for synthesising the particles (for example, water, pressurized CO₂ and products that are precursors of the particles to be synthesised), the other for injecting the coating material or precursor thereof. The attached FIG. 2 illustrates a device with two injection tubes discussed in the “examples”.

For the implementation of the second embodiment of the process of the present invention, it is possible to use a second device, referred to below as “second device”, comprising:
a first reactor for synthesising particles in a pressurized CO₂ medium,
a second reactor for bringing the synthesised particles into contact with the coating material or precursors thereof,
a means of transferring the synthesised particles from the first reactor to the second reactor,
a means of injecting the coating material or precursors of said material into said second reactor,
a means of supplying the device, in particular the first and second reactors, with pressurized CO₂ medium,
valves placed between said reactors and said means,

in which the means of transferring the synthesised particles makes it possible to keep the synthesised particles dispersed in a pressurized CO₂ medium during their transfer from the first to the second reactor, and

in which the means of injecting the coating material is coupled to said second reactor in such a way that the injection of the coating material or precursors thereof into said second reactor does not destroy the dispersion of the particles, in a pressurized CO₂ medium, in said second reactor.

In the second device, the inventors advantageously couple a reactor for synthesis in a pressurized CO₂ medium with a reactor for coating in a pressurized CO₂ medium allowing injection of the coating material, thus preventing any contact between the synthesised particles and the moisture in the air and therefore the agglomeration of the particles. In fact, this agglomeration makes it difficult or even impossible to coat the individualized particles, even if the powder is resuspended in CO₂.

The reactors of this second device may be chosen independently from any one of the reactors known to those skilled in the art for carrying out syntheses in a supercritical medium.

Each reactor may be equipped with a stirrer spindle, and optionally baffles. The role of the spindle and the baffles is explained above.

Advantageously, at least one of the first and second reactors is thermoregulated, generally both reactors. The thermoregulation means may be those known to those skilled in the art, in particular those commonly used in devices for synthesis in a pressurized medium.

This second device is generally equipped with means for supplying said first reactor with pressurized CO₂, with water or organic solvent, and with precursor products, which are pure or in solution, of said particles so as to allow the synthesis of the particles in said first reactor. These means may comprise the same characteristics as those of the first device described above.

At least one of the first and second reactors of this second device may be a tube reactor comprising an inlet at one of its ends and an outlet at the other end. Thus, the particles may be synthesised continuously by injecting the precursors of said particles and the pressurized CO₂ via the first end, and by continuously extracting, in a pressurized CO₂ medium, the synthesised particles via the second end.

For the implementation of a process for manufacturing coated particles continuously, the first and second reactors are preferably tube reactors. According to one particularly advantageous embodiment, in particular for continuous manufacture of coated particles, the first and the second reactors are tube reactors and are assembled in series, in such a way that the outlet of the first reactor is connected to the inlet of the second reactor via the means of transferring the particles from the first reactor to the second reactor.

The tube reactor(s) is (are) preferably removable. This advantageously makes it possible to replace the reactors, for example so as to select their diameter, their shape or their length with the aim of varying the residence time of the reactants in the reactor and therefore of adjusting the rate of progress of the reaction and/or the size of the particles synthesised and/or coated. Generally, the tube reactor is cylindrical in shape, although any elongated shape which promotes contact between the particles and the coating material or precursor thereof is suitable. The tube reactor may, for example, be rectilinear or coiled. The length will be selected according to the desired residence time.

The second reactor may also be in the form of a nozzle, preferably a coaxial nozzle, allowing the particles to be brought into contact with the coating material or precursors thereof, said nozzle comprising a first and a second injection inlet, and also an outlet,
said first injection inlet being connected to the means of transferring the particles so as to be able to inject the transferred particles, in a pressurized CO₂ medium, into said nozzle, and
said second injection inlet being connected to the means of injecting the coating material or precursors thereof so as to be able to inject the coating material or precursors thereof into said nozzle.

The nozzle that can be used in this second device may be defined as being a venturi system, in which the particles and the coating material or precursors thereof are mixed and, optionally, in which the particles are coated. The examples given below illustrate this second variant. In general, when a nozzle is used in the device of the present invention, a nozzle diameter is preferably chosen such that the blocking thereof by the particles and the coating material during the implementation of the process is avoided. This diameter is chosen according to the amount of material which passes through the nozzle, and according to the size of the particles. By way of example, a nozzle having an internal diameter that can range from several hundred microns to a few nanometres will be chosen. Also by way of example, a nozzle having a length a few centimetres to a few tens of centimetres is sufficient for implementing the process of the invention. The nozzle may be of any shape, provided that it performs its function of bringing the particles into contact with the coating material or precursors thereof, and, where appropriate, of being a reactor for coating the particles. For example, it may be cylindrical, cylindroconical or frustoconical shape.

Advantageously, a double-passage coaxial nozzle may be used. For example, the first passage may allow the introduction of the pressurized CO₂ and of the particles to be coated, the second passage being used to inject the coating material, alone, in solution or with pressurized CO₂.

The second reactor may be a reactor for bringing into contact, for coating and for recovering the coated particles. Preferably, the device of the invention comprises, however, one or more reactor(s) for recovering the coated particles.

Thus, this second device may also comprise at least one recovery reactor connected to said second reactor so as to be able to recover the coated particles. For example, the recovery reactor may be connected to the outlet of the second reactor, whether it is a tube or in the form of a nozzle or any other form, so as to be able to recover either the coated particles, or the mixture of particles and of coating material or precursors thereof. For example, when a reactor in the form of a nozzle is involved, said recovery reactor is connected to the outlet of said nozzle.

Advantageously, the second device of the present invention may comprise at least two recovery reactors connected to said second reactor (for example, a nozzle) so as to be able to recover, alternately or successively in each of the recovery reactors, the coated particles or the mixture of coated particles and of coating material or precursors thereof. Thus, when a first recovery reactor is full, the recovery of the coated particles is switched to the second recovery reactor, by means of valves, for example. This switching may be automatically controlled by means of a(an) (optical or mechanical) level detector placed in the recovery reactor and connected to a valve control placed between the second reactor and the recovery reactors. A device comprising several recovery reactors also makes it possible to flush the device into a recovery reactor for example at the beginning and at the end of the process, and to recover the coated particles in one or more recovery reactors other than that used for the flushing. The use of several recovery reactors is particularly suitable for implementing a continuous process for the manufacture of coated particles.

Whatever the type of first and second reactor used, the second device may also comprise a third reactor which is a reactor for preparing the coating material or precursors thereof, connected to the injection means via a means of transferring the coating material or precursors thereof from said third reactor to said second reactor. This means may comprise a tube and a pump as indicated above. This third reactor makes it possible to carry out the abovementioned step (x) of the process of the invention. It may, for example, be a reactor for solubilizing the coating material in a solvent or for synthesising the coating material.

This third reactor may comprise, for example, means for supplying it with solvent, and means for supplying it with coating material or precursors thereof. These means may be simple apertures, for example for introducing a solvent into the reactor, or injection devices, for example for injecting pressurized media. These means are those known to those skilled in the art. They will advantageously make it possible to preserve the containment of the content of the reactor, and of the device as a whole. This third reactor may, for example, be a conventional reactor for solubilizing the coating material or precursors thereof in a solvent, for example pressurized CO₂, the means for supplying it with solvent then being a means of supplying with pressurized CO₂. In this case, the means of transferring the coating material or precursors thereof from said third reactor to said second reactor preferably makes it possible to keep the coating material solubilized in the pressurized CO₂ during its transfer and its injection into said second reactor. This third reactor may also be a conventional reactor, for example for preparing (synthesising) the coating material or precursors thereof before injection. it then comprises, for example, means for supplying it with coating material precursors.

This third reactor may be in any form of reactor known to those skilled in the art, provided that it can perform its function in the device of the present invention. For continuous manufacture of coated particles, a third reactor in the form of a tube reactor, for example such as those mentioned above, will be preferred.

Whatever the device for implementing the process of the invention, it may be equipped with or connected to a depressurizing line equipped with one or more separators and, optionally, with one or more active carbon filters. This makes it possible for the volatile products and gases not to be released into the atmosphere, and for them to be recovered by virtue of the separator. The expansion line makes it possible to return to atmospheric pressure in the reactor. As will emerge in the examples, a single expansion line and a separator may be sufficient for a device comprising several reactors. It is generally connected to a reactor, for example to the reactor for recovering the coated particles.

Whatever the form of the device, it may also comprise at least one automatic expansion valve coupled to a pressure sensor and to a pressure regulator and programmer. Preferably, it will comprise several thereof. This expansion valve, this sensor and this regulator make it possible to ensure and to control the safety of the device when it is used to implement the process of the invention. These valves, sensors and regulators may be those commonly used in devices for implementing processes in a pressurized medium.

In the device, whatever its form, the synthesis reactor may also comprise at least one temperature sensor connected to a temperature regulator and programmer and also an automatic expansion valve and a pressure sensor connected to a pressure regulator and programmer. Preferably, it will comprise several thereof, for example at the level of each reactor. These sensors and regulators may be those commonly used in devices for implementing processes in a pressurized medium, such as a supercritical medium.

The original combination of the various elements which constitute the devices forms a system capable of producing a ready-to-use coated inorganic or organic powder. In its preferred embodiments, this system preferably comprises one or more of the following elements, preferably all:
a variable- or adjustable-flow-rate injection system for rapidly introducing the precursors and/or the materials for coating (for example for implementing the semi-continuous or continuous process);
a thermoregulated and removable tube reactor for producing the inorganic or organic particles (for example, continuous or semi-continuous process);
two separate means of injecting the coating material and the particles, for example for implementing SAS and/or RESS processes, continuously or semi-continuously;
a system for dry or wet recovery of the powders: for example, recovery of the powders in the form of a solution of a dispersion in a suitable aqueous or organic medium, for example alcoholic medium;
possibility of performing direct coating by synthesis (polymerization or inorganic synthesis) by addition of a reactor in series (for example, continuous or semi-continuous process).

The present invention combining one or more of the abovementioned elements, preferably all, allows the synthesis and coating of particles according to a standardized protocol. This protocol is defined in such a way as to obtain homogeneous coated-particle sizes and distribution. The synthesis may involve inorganic or organic particles. The coating material which enables the coating of these particles may, similarly, be inorganic or organic in nature.

It may be a coating material, also referred to as coating agent, which can be chosen from the examples given below. It may, for example, be:
a sintering agent, for example chosen from Al₂O₃, Y₂O₃, SiC, FeO, MgO, etc., for activating or reducing the phase transformations which are involved during sintering.
A friction agent or an anti-wear agent, for example chosen from AlO₃, SiO₂, etc.
A plasticizer, chosen, for example, from polyethylene glycol, dibutyl phthalate, etc., for cohesion of the crude ceramic bands produced by casting.
A dispersant, for example an organic deflocculating polyelectrolyte or polymer, acting on electrostatic repulsion or on steric stabilization.
A crosslinking agent, for example chosen from N,N′-methylenebisacrylamide, N,N′-bisacrylylcystamine, N,N′-diallyltartradiamide, etc., for obtaining polyacrylamide gels crosslinked in a three-dimensional network for the insertion of various cations.
A metallizing agent, chosen, for example, from Ag, Pd, Pt, etc., used for its electrically conducting properties.
An agent used as a metallic binder, chosen, for example, from nickel, chromium, titanium, etc., for its anti-corrosion and anti-abrasion properties.

In addition to the abovementioned examples, the coating process of the present invention makes it possible, for example, to produce catalysts such as Ti/Pd, Ti/Pt, etc., and also the coating of metals of the TiO₂ type with a noble metal, for example Pd or Pt.

Also by way of example, the present invention makes it possible in particular to manufacture coated particles chosen from yttrium-doped zirconium oxide particles coated with poly(methyl methacrylate), metal oxide catalyst particles coated with a noble metal, such as Ti oxide particles coated with Pd or Pt, and titanium dioxide particles coated with a polymer.

The present invention enables the synthesis, in pressurized CO₂ medium, such as a supercritical CO₂ medium, of particles, for example of ceramic oxides and the like, as indicated above, and the in-situ coating thereof.

The present invention makes it possible to carry out manufacturing of coated particles on the industrial scale. It enables the synthesis of a large amount of coated oxide powders, in particular of nanophase powders of at least one oxide.

The figures and examples below illustrate various embodiments implementing the present invention.

### BRIEF DESCRIPTION OF THE FIGURES

FIG. 1: Scheme of a device in accordance with the present invention that can be used to implement the process of the present invention according to a first embodiment, with a view to semi-continuous synthesis, in a supercritical CO₂ medium, of coated ceramic oxides.

FIG. 2: Scheme of a connection between the reactor and the injection system that can be used in a device according to the invention such as that represented in FIG. 1.

FIG. 3: Scheme of a device in accordance with the present invention comprising as second reactor a nozzle or a tube reactor (st2), it being possible for said device to be used to implement the process of the present invention according to its second embodiment, with a view to continuous synthesis, in a pressurized CO₂ medium, of coated oxide particles.

FIG. 4: Scheme of a device in accordance with the present invention comprising a first and a second tube reactor, it being possible for said device to be used to implement the process of the present invention according to its second embodiment, with a view to synthesis of oxide particles followed by coating thereof by chemical reaction.

FIG. 5: Scheme of a nozzle that can be used as second reactor in the device represented in attached FIG. 3.

### EXAMPLES

### Example 1

### Device According to the Invention that Can Be Used for Semi-Continuous Manufacture of Coated Particles According to the Process of the Invention

### Device

The device presented in this example makes it possible to implement the process of the invention according to the first embodiment disclosed above.

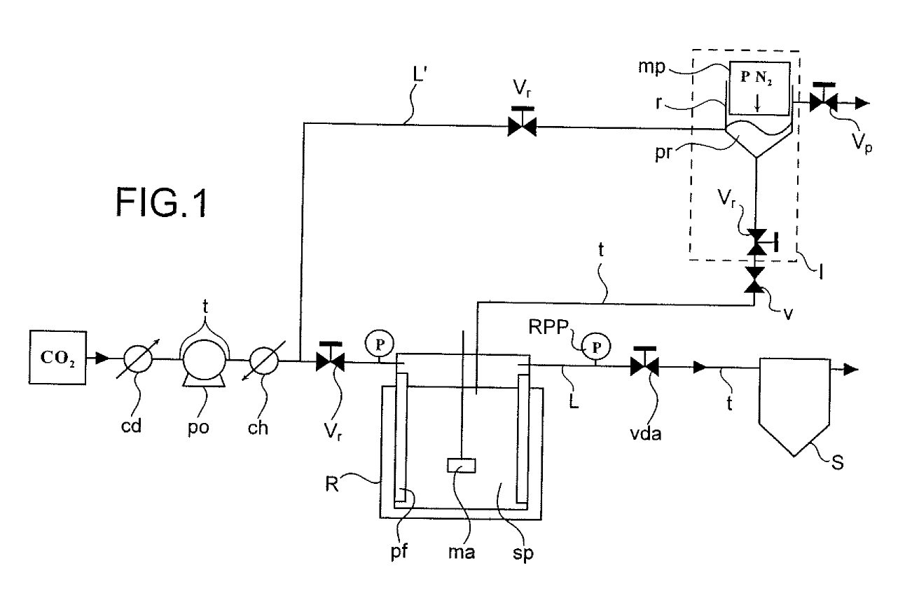

This device is represented schematically in attached FIG. 1. It is based on a reactor (R) for synthesis in a conventional supercritical CO₂ medium connected to a means of supplying with supercritical CO₂ comprising a stock of liquid CO₂ (CO₂), a condenser (cd), a pump (po) and a means of heating (ch) the CO₂ injected into the reactor.

This reactor (R) serves as a reactor for synthesising the particles in a supercritical CO₂ medium and as a reactor for coating the synthesised particles. It is equipped with a stirrer spindle (ma) and baffles (pf). It may also be equipped with a means of heating and regulating the temperature of the reactants present inside the reactor (not represented).

The reactor is also connected to an injection system (l) which can be used, depending on the process carried out, for injecting materials that are precursors of the particles into the reactor and/or for injecting the coating material or the precursors of said material. The injection system is thermoregulated. It is itself also connected to the abovementioned CO₂ stock by means of a line (L′) equipped with a regulating valve (Vr) (useful, for example, for applications using the RESS process). The injection system (l) comprises a pressure multiplier (mp) and a reactor (r) intended to contain or to inject the coating material precursors (pr) or the coating material, and, before this, optionally, the particle precursor material. This injection system is also equipped with a flush valve (Vp). Another type of injection system could be used, such as a metering pump or a syringe pump.

This device also comprises an expansion line (L) equipped with a separator (S) and with a pressure sensor (P), and also a pressure regulator and programmer (RPP).

A set of leaktight pipes (t), allowing the circulation of supercritical fluids, connects the various elements of the device represented in this figure. A set of regulating valves (vr), of automatic expansion valves (vda) and of valves (v) placed on these pipes makes it possible to control the circulation of the fluids in this device, and, at the end of the process, to depressurize the reactor for recovery of the coated particles.

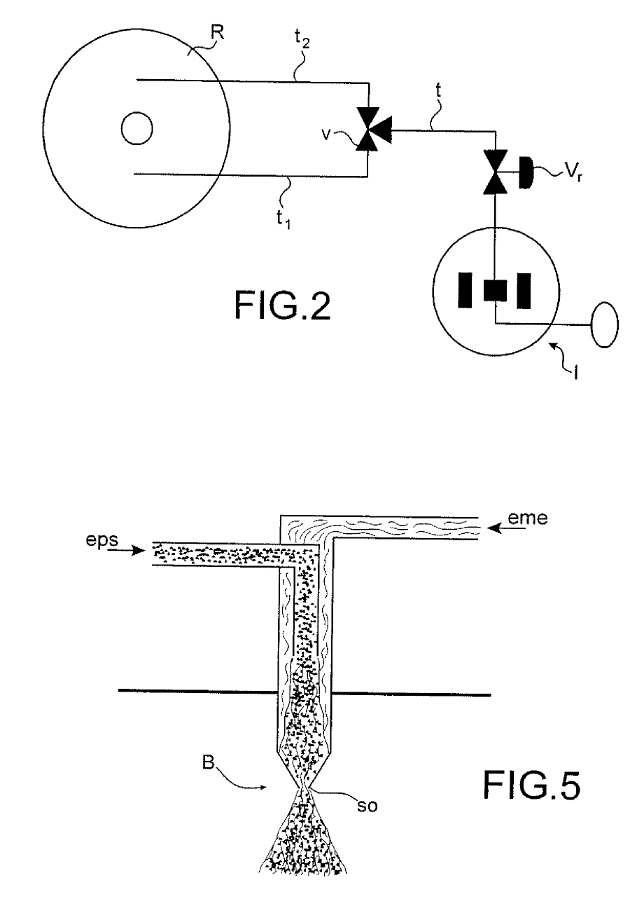

Attached FIG. 2 represents a scheme (viewed from above in section) for connection between the reactor (R) and the injection system (l) making it possible to overcome the problem of clogging of the injection tube after the step of synthesising the particles, and to facilitate the intermediate cleaning of the system. Two injection tubes are provided for the injection into the reactor (R): the first tube (t1) is used to inject the materials for synthesising the particles. The second tube (t2) is used to inject the coating material or precursors thereof. An injection system (l) as indicated above is provided. There is an expansion valve (v) and a regulating valve (Vr). This connection makes it possible to facilitate the intermediate cleaning of the system, two injection tubes being used. In the event of clogging of the first tube during the synthesis of the particles, for example, it is thus possible to use the second tube to carry out the coating step.

Operating of this Device

By way of operating example, mention is made of two types of synthesis process in accordance with the present invention which can be carried out on this device.

The first type of process consists in prefilling the reactor (R) with a solution of precursor (sp) of the particles to be synthesised, and then increasing the temperature and CO₂ pressure in the system so as to reach the operating conditions chosen for the synthesis of the particles in said reactor.

The second type of synthesis process consists in injecting a solution of precursor (sp) with the injection system (l) into the reactor preloaded with CO₂ at the synthesis temperatures and pressures. When this second type of synthesis process is used, the coating is carried out after cleaning of the injection system (l) introduction line.

An important step lies between the step of synthesising the particles and the coating step, in order for the reactor (R) to be, after injection, under the conditions favourable to the coating (temperature, pressure, etc.).

Examples 4 and 5 below are examples of use of the device described in this example, for the manufacture of coated particles.

### Example 2

### Device According to the Invention that Can Be Used for Continuous Manufacture of Coated Particles According to the Process of the Invention

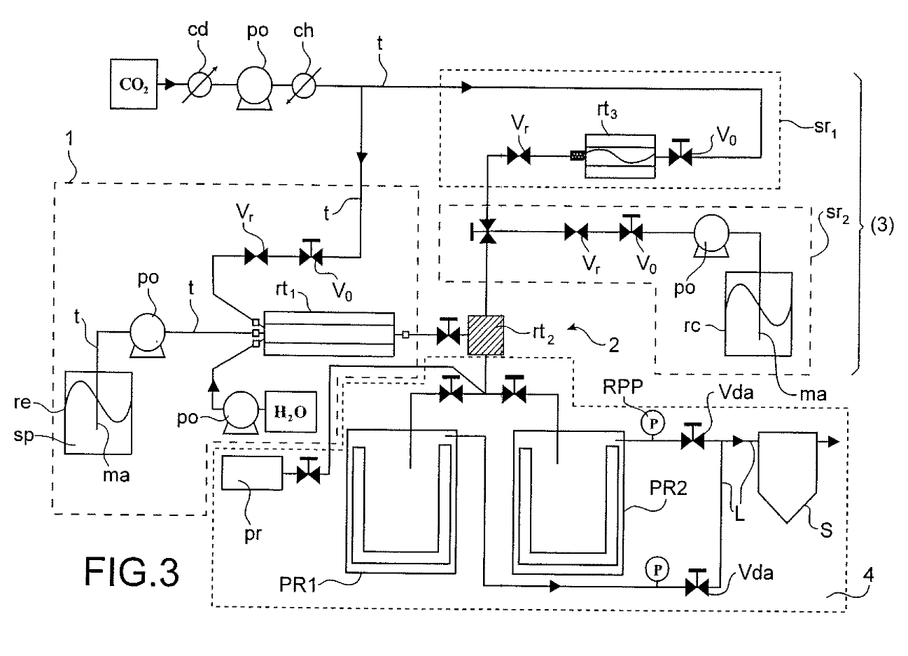

The device presented in this example can be used for continuous synthesis of coated particles. It is represented schematically in attached FIG. 3. This device is described below in four parts.

A first part (1) of this device is used for synthesising the powders of oxide particles. It consists of a tube reactor (rt1), which is thermoregulated and removable in order to be able to modify the geometry thereof (coil of different sizes) and adjust the residence time. This tube reactor is connected to a liquid CO₂ stock (CO₂), to a stock (re) of precursor solution (sp) in the form of a reservoir—optionally equipped with a mechanical or magnetic stirring means (ma)—and to a reactant stock (water, alcohols, gas, etc.) referenced “H₂O” on the figure. Pumps (po) make it possible to continuously supply the reactor (rt1) with CO₂, precursor solutions and reactants.

Tubes (t) connect these various elements. Flow rate regulating valves (vr) and on/off valves (vo) make it possible to regulate the flows of materials in the device and to depressurize the device, respectively.

A second part (2) is dedicated to the coating (coating zone). It comprises a second reactor (rt2) for bringing the synthesised particles into contact with the coating material or precursor thereof. This second reactor is a nozzle (B) such as that represented in FIG. 5, comprising an inlet (eps) for the synthesised particles, an inlet (eme) for the coating material or precursors thereof, and an outlet (so) for the coated particles or a mixture of the particles and of the coating material or precursors thereof. This nozzle makes it possible, for example, to implement RESS or SAS processes for coating the particles.

A third part (3) of the device makes it possible to prepare the coating material or precursors thereof. On the device represented, two preparation means (sr1) and (sr2) (each constituting a “third reactor”) are assembled. The most suitable means is chosen according to the process for manufacturing the coated particles that is used. The means (sr1) or (sr2) which is not used may, of course, be absent from the device.

The means “sr1” comprises a tube reactor for continuously preparing the coating material or precursors thereof. The means “sr2” comprises a conventional reactor for precipitating or solubilizing the coating material or precursors thereof. These means make it possible to implement two different types of processes: RESS and SAS. For the RESS process, use is made of an extraction unit in the form of the tube reactor (rt3) for solubilizing the coating agent in the CO₂ (sr1). This extraction unit is connected to the liquid CO₂ stock (CO₂). For the SAS process, use is made of a conventional reactor (rc) which may contain an organic or inorganic solution for solubilizing the coating agent or precursors thereof. This conventional reactor (rc) may be equipped with a mechanical or magnetic stirring means (ma). The solubilized coating agent or precursors thereof is/are transported by a pump (po) (sr2) so as to be injected into the second reactor (rt2). Tubes (t), on/off valves (vo), regulating valves (vr) and valves (v) are provided.

A fourth part (4) of the device represented is dedicated to the recovery of the coated powders. This part consists of three recovery containers “pr”, “PR1” and “PR2”. The containers “pr”, “PR1” and “PR2” are mounted in parallel so as to be able to switch between them, for example to the second container “PR2” when the first container “PR1” is full. The first container “pr” makes it possible to recover and isolate the first particles obtained during the initiation of the synthesis, up until the nominal operating regime is attained. Next, the recovery is carried out successively or alternately in the containers “PR1” and “PR2”. “PR1” and “PR2” are such that they can contain a solvent or a solution in order to be able to recover the powders and coated particles manufactured in the form of a dispersion.

This device also comprises automatic flow rate valves (vda), expansion lines (L) equipped with a separator (S) and with a pressure sensor (P), and also a pressure regulator and programmer (RPP). The means of supplying with supercritical CO₂ comprises a liquid CO₂ stock (CO₂), a condenser (cd), a pump (po) and a means of heating (ch) the CO₂ injected into the reactors.

This assembly is polyvalent. It can be used independently, for example, for synthesising oxide particles by chemical reaction, for formulating various materials via RESS or SAS processes and for synthesising coated oxide particles, for example by RESS or SAS reaction.

Operating of this Device

The oxide particles continuously manufactured in the first reactor (rt1) are continuously injected into the second reactor (rt2) at the same time as the coating material or precursors thereof prepared in the third reactor ((rt3) or (rc)). The coated particles are recovered continuously, alternately in the recovery containers (PR1) and (PR2).

Examples 6 and 7 below are examples of use of the device described in this example, for the manufacture of coated particles.

### Example 3

Device According to the Invention that Can Be Used for Continuous Manufacturing of Coated Particles According to the Process of the Invention

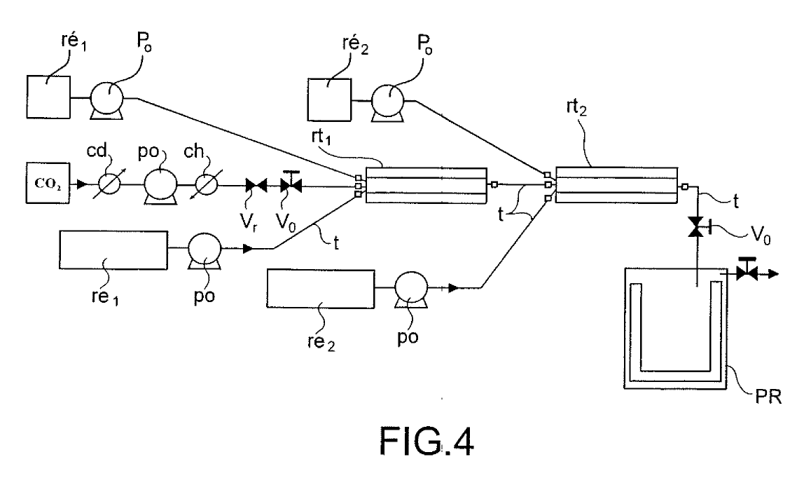

The device described in this example derives from that of Example 2. It is represented schematically in FIG. 4. The various elements represented in this figure have already been referenced in Examples 1 and 2 and in FIGS. 1 and 3.

In this device, the first and the second reactors (rt1 and rt2) are tube reactors and are mounted in series, such that the outlet of the first reactor (rt1) is connected to the inlet of the second reactor (rt2) via a transfer means which, in this case, is a tube (t) for transporting the synthesised oxide particles from the first to the second reactor in a supercritical medium.

Each of the reactors is respectively connected to a reservoir (re1) (and optionally (re′1)) and (re2) (and optionally (re′2)) for feeding it with reactant. For the first reactor (rt1), the reactants are those used for the manufacture of the oxide particles. For the second reactor (rt2), the reactants are those constituting the coating material or precursor thereof.

In the interests of simplification, only one recovery container (PR) is represented. However, this device also comprises, like the device represented in FIG. 3, several recovery containers.

Operating of this Device

The oxide particles manufactured continuously in the first reactor (rt1) are injected continuously into the second reactor (rt2) at the same time as the coating material or precursors thereof. The coated particles are recovered continuously, from the second reactor (rt2), alternately in the recovery containers.

Example 8 below is an example of use of this device for the manufacture of coated particles.

### Example 4

First Example of Manufacture of Coated Particles According to the Process of the Invention Using the Device Described in Example 1

The coated particles manufactured in this example are yttriated zirconium oxide particles coated with poly(methyl methacrylate).

The precursors of the yttriated zirconium oxide particles are zirconium hydroxyacetate (0.7 mol/L) and yttrium acetate (0.05 to 0.2 mol/L). They are solubilized in an organic solvent (alcohol, acetone or alkane) in the presence of nitric acid (5 to 20% relative to the total volume of the solvent). The choice of solvent conditions the synthesis process and the synthesis temperature. Two solvents were studied: pentane and isopropanol.

For pentane, the crystallization temperature is 200-250° C. at 300 bar of CO₂. A gel forms in the solution after ageing for 20 minutes, before treatment with the CO₂, thereby making it impossible to inject the precursor solution. Only the batch process (where the solution undergoes a temperature and pressure increase phase and then a hold at the crystallization temperature of between 15 minutes and 4 hours) is envisaged for this type of solution.

For isopropanol, the crystallization temperature is 350° C. at 300 bar of CO₂. The solution obtained is transparent and fluid. The two processes (batch or injection) can be envisaged.

For the coating with poly(methyl methacrylate), the precursors used are a monomer (methyl methacrylate), with a surfactant (Pluronic) at a content of 3%-15% by weight relative to the weight of the monomer, an initiator (AiBN) at a content of 1% to 10% by weight relative to the weight of the monomer, and a solvent, isopropanol, which facilitates the solubilization of the precursors and the injection thereof. The synthesis temperature is between 60 and 150° C. and the pressure is between 100 and 300 bar. A hold of 3 to 5 hours at the synthesis temperature is required for the reaction.

The various phases of the intermediate step between the synthesis and the coating comprise sweeping with CO₂ for a period of 15 minutes, then interruption of the thermoregulation of the reactor, followed by readjustment of the pressure in order to achieve the conditions required for the coating.

The characteristics of the particles depend on the solvent used.

For pentane, the size of the crystallites ranges between 15 and 35 nm, the size of the particles between 30 and 300 nm and the specific surface area between 10 and 100 m²/g. For isopropanol with the batch process, the size of the crystallites ranges between 4 and 8 nm, the size of the particles between 100 nm and 3 μm and the specific surface area between 150 and 250 m²/g. For isopropanol with the process by injection, the size of the crystallites ranges between 4 and 8 nm, the size of the particles between 40 and 200 nm and the specific surface area between 150 and 250 m²/g.

The thickness of the polymer coating depends on the amounts of precursor and on the reaction time.

The calculations give values of between 0.1 nm (uneven coating) and 5 nm.

### Example 5

Second Example of Manufacture of Coated Particles According to the Process of the Invention Using the Device Described in Example 1

The coated particles manufactured in this example are particles of titanium dioxide coated with poly(methyl methacrylate) or another polymer (such as polyethylene glycol (PEG)).

The synthesis precursor used to prepare the titanium dioxide is titanium tetraisopropoxide. This precursor is an alkoxide that is relatively soluble in CO₂. It may be used pure or in solution in isopropanol, it may be either placed directly in the reactor or injected. Water is subsequently injected into the reactor at the synthesis temperature (>250° C.) in order to allow hydrolysis of the precursor. The reaction may also be carried out without water, the titanium dioxide then being obtained by thermal decomposition of the precursor.

Particles ranging from 50 to 600 nm and crystallite sizes of between 10 and 30 nm may be obtained. The specific surface area obtained for a titanium dioxide powder crystallized into anatase phase (synthesis temperature=250° C.) is approximately 120 m²/g.

The coating step is equivalent to that described in Example 4 with the same polymer or a polyethylene glycol.

Another coating technique consists in injecting a polymer solubilized in carbon dioxide (for example, fluoropolymer, polysiloxane, polyethylene glycol) into the reactor loaded with carbon dioxide (at a sufficiently high temperature and pressure for the polymer to be solubilized) and then allowing the reactor temperature and pressure to drop until the polymer precipitates on the particles.

A final coating technique (RESS) consists in injecting a polymer solubilized in carbon dioxide (for example, fluoropolymer, polysiloxane or polyethylene glycol) into the reactor weakly loaded with carbon dioxide (at a sufficiently low temperature and pressure for the polymer to precipitate).

### Example 6

First Example of Manufacture of Coated Particles According to the Process of the Invention Using the Device Described in Example 2 in Which the Second Reactor is a Nozzle

The coated particles manufactured in this example are ceramic oxide particles coated by means of an RESS process. The process is carried out so as to obtain continuous manufacture.

The particles may, for example, be gadolinium-doped ceria or yttrium-doped zirconium oxide (synthesis by injection described in Example 4). A solution prepared, for example, from cerium acetate and gadolinium acetate in isopropanol and nitric acid is injected into the first reactor simultaneously with the carbon dioxide. The reactor 1 should be thermostated at a temperature above 150° C. in order to obtain a crystallized powder. The powder is transferred to the nozzle rt2.

In order to have some idea of the characteristics that can be obtained with these powders, gadolinium-doped ceria was synthesised in batch mode with various solvents. Various morphologies were obtained: platelets, rods, fibres, porous spheres. Specific surface areas of greater than 100 m²/g could be measured. The synthesis of these powders by injection was not carried out. By suitability with respect to the results obtained for the doped zirconium oxide, the use of suitable operating conditions, with this process by injection, should make it possible to obtain spherical monodispersed particles of nanometric sizes (30 to 300 nm).

A coating agent that is soluble in CO₂ should be used. It may, for example, be paraffin. The solubilization is carried out in the reactor rt3. The CO₂ loaded with coating agent is transported to the nozzle rt₂.

The recovery container is at atmospheric pressure and ambient temperature (or low CO₂ pressure and low temperature), and therefore, at the outlet of the nozzle, the coating agent (solid under the ambient conditions) precipitates on the particles.

### Example 7

Second Example of Manufacture of Coated Particles According to the Process of the Invention Using the Device Described in Example 2 in Which the Second Reactor (rt2) is a Tube Reactor

The coated particles manufactured in this example are ceramic oxide particles coated by means of an SAS process. The process is carried out so as to obtain continuous manufacture.

The particles may, for example, be of titanium dioxide TiO₂. The precursor of the oxide, titanium tetraisopropoxide, is injected into the first reactor simultaneously with the CO₂ and with the water (3 inlets). The reactor 1 should be thermostated at a temperature above 250° C. in order to obtain a crystallized powder. The powder is transferred to the nozzle rt2. The characteristics of the titanium powders obtained are identical to those of Example 5.

A coating agent that is insoluble in CO₂ should be used. A solution of the precursor should be prepared. It may, for example, be a polymer solubilized in a suitable organic solvent. The solution of coating agent is in (rc) and is then transported to the nozzle (rt2).

The nozzle (rc) makes it possible for the coating agent to be brought into contact with the CO₂; the coating agent precipitates on the particles.

### Example 5

Example of Manufacture of Coated Particles According to the Process of the Invention Using the Device Described in Example 3

The synthesis of silica is carried out in a manner equivalent to the synthesis described above in Example 7. The synthesised particles are transferred to a second tube synthesis reactor rt2. The characteristics of the silica powders obtained by means of this process are unknown, but amorphous silica powders were obtained by means of the batch process at 100° C.; the particles obtained are submicronic and porous and the powders have high specific surface areas (>700 m²g).

The precursor solution is prepared beforehand (re2 in FIG. 4); it may be a solution of polymerization precursors as in Example 4 (monomer, surfactant, initiator, solvent), a solution of oxide precursor as for the synthesis (cerium acetate in isopropanol) or a solution of noble metal precursor (platinum precursor in water). The solution is injected into rt2 simultaneously with the particles.

The reaction of the coating agent precursors takes place in rt2 around the particles synthesised in rt1. It may be a polymerization reaction (60 to 150° C.), a sol-gel reaction or a precipitation (150 to 500° C.) or a thermal decomposition (150 to 500° C.),

The coating therefore takes place in rt2, and then the recovery of the coated particles takes place at the outlet of this second reactor.

### Example 9

This example illustrates the influence of the injecting and stirring speed in the particle synthesis reactor on the control of the size, the size distribution and the crystalline structure of said particles.

The particles prepared are yttriated zirconium oxide particles.

A solution of precursors (zirconium hydroxyacetate and yttrium acetate in proportions so as to obtain a final concentration of 3 mol % of Y₂O₃ relative to ZrO₂) is injected at a low speed (0.19 m/s) into the reactor of FIG. 1 stirred at 400 rpm under a CO₂ pressure of 230 bar and a temperature of 350° C. The pressure in the reactor after injection is 300 bar. The treatment in a supercritical medium was maintained for 1 hour before depressurization of the reactor and return to ambient temperature. The X-ray diffraction analysis shows that this powder crystallized in a cubic system, a single peak being observed for 2θ=35°, whereas the concentrations of precursors used conventionally result in a quadratic powder being obtained. This result could be reproduced with an injecting speed of 0.27 m/s. The tests carried out with injecting speeds higher than 0.5 m/s result in the synthesis of a crystallized powder in the quadratic phase.

Once synthesised, these powders can be coated in accordance with the process of the invention.

### LIST OF REFERENCES

[1] R. Subramanian, P. Shankar, S. Kavithaa, S. S. Ramakrishnan, P. C. Angelo, H. Venkataraman, Synthesis of nanocrystalline yttria by sol-gel method. Materials Letters, 2001, 48: p. 342-346.
[2] L. Znaidi, K. Chhor, C. Pommier, Batch and semi-continuous synthesis of magnesium oxide powders from hydrolysis and supercritical treatment of Mg(OCH₃)₂. Materials Research Bulletin, 1996, 31(12): p. 1527-1535.
[3] T. Adshiri, K. Kanazawa, K. Arai, Rapid and continuous hydrothermal synthesis of boehmite particles in subcritical and supercritical water. Journal of American Ceramic Society, 1992, 75(9): p. 2615-2618.
[4] T. Adshiri, Y. Hakuta, K. Arai, Hydrothermal synthesis of metal oxide fine particles at supercritical conditions. Industrial and Engineering Chemistry Research, 2000, 39; p. 4901-4907.
[5] A. A. Galkin, B. G. Kostyuk, V. V. Lunin, M. Poliakoff, Continuous reactions in supercritical water: a new route to La₂CuO₄ with a high surface area and enhanced oxygen mobility. Angew. Chem. Int. Ed., 2000, 39(15): p. 2738-740.
[6] Y. V. Kolen'ko, A. A. Burukhin, B. R. Churagulov, N. N. Oleinikov, V. A. Mukhanov, Hydrothermal synthesis of nanocrystalline powders of various crystalline phase of ZrO₂ and TiO₂. Russian Journal of Inorganic Chemistry, 2002, 47(11): p. 1609-1615.
[7] R. Viswanathan, R. B. Gupta, Formation of zinc oxide nanoparticles in supercritical water. Journal of Supercritical Fluids, 2003, 27: p. 187-193.
[8] C. Pommier, K. Chhor, J. F. Bocquet, M. Barj, Reactions in supercritical fluids, a new route for oxide ceramic powder elaboration, synthesis of spinel MgAl₂O₄. Mat. Res. Bull., 1990, 25: p. 213-221.
[9] K. Chhor, J. F. Bocquet, C. Pommier, Syntheses of submicron TiO₂ powders in vapor, liquid and supercritical phases, a comparative study. Materials Chemistry and Physics, 1992, 32: p. 249-254.
[10] C. Pommier, K. Chhor, J. F. Bocquet, The use of supercritical fluids as reaction medium for ceramic powder synthesis. Silicates Industriels, 1994, 59(3-4): p. 141-143.
[11] K. Chhor, S.F. Bocquet, C. Pommier, Materials science communication—Syntheses of submicron magnesium oxide powders. Materials Chemistry and Physics, 1995, 40(1): p. 63-68.
[12] L. Znaidi, R. Séraphimova, J. F. Bocquet, C. Colbeau-Justin, C. Pommier, A semi-continuous process for the synthesis of nanosize TiO2 powders and their use as photocatalysts. Materials Research Bulletin, 2001, 36: p. 811-825.
[13] D. A. Loy, E. M. Russick, S. A. Yamanaka, B. M. Baugher, Direct formation of aerogels by sol-gel polymerizations of alkoxysilanes in supercritical carbon dioxide. Chemistry of Materials, 1997, 9: p. 2264-2268.
[14] S. Sarrade L. Schrive, C. Guizard, A. Julbe, Manufacture of single or mixed metal oxides or silicon oxide, in PCT Int., 1998, WO9851613: France.
[15] S. Papet, Etude de la synthese de materiaux inorganiques en milieu CO₂ supercritique, application à l'élaboration de membranes minérales de filtration tangentielle. [Study of the synthesis of inorganic materials in a supercritical CO₂ medium, application to the production of mineral membranes for tangential filtration] 2000, University Montpellier II—Sciences and Techniques of Languedoc, Montpellier.
[16] O. Robbe, Elaboration de poudres et de membranes céramiques conductrices par procédé sol-gel assisté par du CO₂ supercritique. [Production of conductive ceramic powders and membranes by supercritical CO₂-assisted sol-gel process] 2003, University Montpellier II, Sciences and Techniques of Languedoc, Montpellier.
[17] E. Reverchon, G. Caputo, S. Correra, P. Cesti, Synthesis of titanium hydroxide nanoparticles in supercritical carbon dioxide on the pilot scale. Journal of Supercritical Fluids, 2002, 00: p. 1-9.
[18] C. H. M. Caris, L. P. M. van Elven, A. M. van Herk, A. L. German, Polymerization of MMA at the surface of inorganic submicron particles. British Polymer Journal, 1989, 21: p. 133-140.
[19] J-W. Shim, J-W. Kim, S-H. Han, I-S. Chang, H-K. Kim, H-H. Kang, O-S. Lee, K-D. Suh, Zinc oxide/polymethylmethacrylate composite microspheres by in situ suspension polymerization and their morphological study. Colloids and Surfaces A: Physicochemical and Engineering Aspects, 2002, 207: p. 105-111.
[20] J. Richard, J-P. Benoït, Microencapsulation. Techniques de l'ingénieur [Techniques for the engineer], 2000, J 2 210.
[21] J. Jung, M. Perrut, Particle design using supercritical fluids: Literature and patent survey. Journal of Supercritical Fluids, 2001, 20: p. 179-219.
J-H. Kim, T. E. Paxton, D. L. Tomasko, Microencapsulation of naproxen using rapid expansion of supercritical solutions. Biotechnol. Prog, 1996, 12: p. 650-661.
[23] Y. Wang, D. Wei, R. Dave, R. Pfeffer, M. Sauceau; J-J. Letourneau, J. Fages, Extraction and precipitation particle coating using supercritical CO₂. Powder Technology, 2002, 127: p. 32-44.
[24] K. Matsuyama, K. Mishima, K-I. Hayashi, H. Ishikawa, H. Matsuyama, T. Harada, Formation of microcapsules of medicines by the rapid expansion of a supercritical solution with a nonsolvent. Journal of Applied Polymer Science, 2003, 89: p. 742-752.
[25] K. Mishima, K. Matsuyama, D. Tanabe, S. Yamauchi, T.J. Young, K. P. Johnston, Microencapsulation of proteins by rapid expansion of supercritical solution with a nonsolvent. AIchE Journal, 2000, 46(4): p. 857-865.
[26] T-J. Wang, A. Tsutsumi, H. Hasegawa, T. Mineo, Mechanism of particle coating granulation with RESS process in fluidized bed. Powder Technology, 2001, 118: p. 229-235.
[27] A. Tsutsumi, S. Nakamoto, T. Minco, K. Yoshida, A novel fluidized-bed coating of fine particles by rapid expansion of supercritical fluid solutions. Powder Technology, 1995, 85: p. 275-278.
[28] N. Elvassore, A. Bertucco, P. Caliteci, Production of protein-loaded polymeric microcapsules by compressed CO₂ in a mixed solvent. Industrial and Engineering Chemistry Research, 2001, 40: p. 795-800.
[29] J. Bleich, B. W. Müller, Production of drug loaded microparticles by the use of supercritical gases with the aerosol solvent extraction system (ASES) process. Journal of Microencapsulation, 1996, 13(2): p. 131-139.
[30] I. Ribeiro Dos Santos, J. Richard, B. Pech, C. Thies, J-P. Benoït, Microencapsulation of protein particles within lipids using a novel supercritical fluid process. International Journal of Pharmaceutics, 2002, 242: p. 69-78.
[31] B. Yue, J. Yang, C-Y. Huang, R. Dave, R. Pfeffer, Particle encapsulation with polymers via in situ polymerization in supercritical CO₂. Powder Technology, 2004, 146: p. 32-45.
[32] Y. Chernyac, F. Henon, R. B. Harris, R. D. Gould, R. K. Franklin, J. R. Edwards, J. M. DeSimone, R. G. Carbonell, Formation of perfluoropolyether coating by rapid expansion of supercritical solutions (RESS) process. Part 1: experimental results. Industrial and Engineering Chemistry Research, 2001, 40: p. 6118-6126.
[33] K. Matsuyama, K. Mishima, K. Hayashi, H. Matsuyama, Microencapsulation of TiO₂ nanoparticles with polymer by rapid expansion of supercritical solution. Journal of Nanoparticles Research, 2003, 5: p. 87-95.
[34] K. Matsuyama, K. Mishima, K. Hayashi, R. Ohdate, Preparation of composite Polymer-SiO₂ particles by rapid expansion of supercritical solution with a nonsolvent. Journal of Chemical Engineering of Japan, 2003, 36(10): p. 1216-1221.
[35] R. Schreiber, C. Vogt, J. Werther, G. Brunner, Fluidized bed coating at supercritical fluid conditions. Journal of Supercritical Fluids, 2002, 24. p. 137-151.
[36] A-M. Juppo, A. Larsson, M-L. Andersson, C. Boissier, Incorporation of active substances in carrier matrixes. 2002, U.S. Pat. No. 6,372,260.
[37] A. D. Shine, J. Gelb Jr., Microencapsulation process using supercritical fluids. 1998, U.S. Pat. No. 5,766,637.
[38] E. M. Glebov, L. Yuan, L. G. Krishtopa, O. M. Usov, L. N. Krasnoperov, Materials and interfaces—Coating of metal powders with polymers in supercritical carbon dioxide. Industrial and Engineering Chemistry Research, 2001, 40: p. 4058-4068.
[39] J. Yang, B. Yue, C-Y. Huang, R. Dave, R. Pfeffer, Silica PMMA nanocomposite synthesis in supercritical CO2 (poster), The 227th ACS National Meeting, Editor. 2004: Anaheim.

1. Process for manufacturing particles coated with a coating material, said process comprising the following steps:
(a) synthesising particles in a pressurized CO₂ medium,
(b) bringing the synthesised particles and the coating material or the precursors of said material into contact, in a pressurized CO₂ medium,
(c) coating the synthesised particles with the coating material, using the coating material directly, or after conversion of the precursors of the coating material into said coating material, and
(d) recovering the coated particles,
steps (a) and (b) being coupled such that the particles synthesised in step (a) remain dispersed in a pressurized CO₂ medium at least until step (c).

2. Process according to claim 1, in which the process is a batch, semi-continuous or continuous process.

3. Process according to claim 1, in which step (a) of synthesising the particles is followed by a step of sweeping the synthesised particles with pressurized CO₂ before carrying out step (b) of bringing said particles into contact with the coating material or precursors thereof.

4. Process according to claim 1, also comprising a step (x) of preparing the coating material before step (b) of bringing into contact.

5. Process according to claim 4, in which step (x) of preparing the coating material is either a synthesis of the coating material which uses a process chosen from a sol-gel process, a polymerization process, a prepolymerizaton process, a thermal decomposition process, or an organic or inorganic synthesis process; or a solubilization of the coating material in a solvent or in a pressurized CO₂ medium.

6. Process according to claim 1, in which step (a) of synthesising the particles and step (b) of bringing said particles into contact with the coating material or precursors thereof are carried out in the same reactor.

7. Process according to claim 6, in which step (b) of bringing into contact consists in injecting the coating material or precursors thereof into said reactor containing the synthesised particles in a pressurized CO₂ medium.

8. Process according to claim 1, in which step (a) of synthesising the particles is carried out in a first reactor, the synthesised particles being transferred, in a pressurized CO₂ medium, into a second reactor, step (b) of bringing said synthesised particles into contact with the coating material or precursors thereof being carried out in said second reactor.

9. Process according to claim 8, in which the particles are transferred into the second reactor continuously or semi-continuously.

10. Process according to claim 8, in which step (h) of bringing into contact consists in injecting the coating material or precursors thereof into said second reactor containing, in a pressurized CO₂ medium, the synthesised particles.

11. Process according to claim 8, in which the coating material or precursors thereof is in a pressurized CO₂ medium when it is injected into said reactor.

12. Process according to claim 8, in which the coating material or precursors thereof is in an inorganic medium when it is injected into said reactor.

13. Process according to claim 8, in which step (b) of bringing said synthesised particles into contact with the coating material or precursors thereof is carried out in said second reactor, this second reactor being a nozzle comprising a first and a second injection inlet, and also an outlet;
in which the synthesised particles, in a pressurized CO₂ medium, are injected via the first inlet of the nozzle, and, at the same time as said particles, the coating material or precursors thereof is/are injected via the second inlet, in such a way that the bringing into contact of the synthesised particles with the coating material or precursors thereof is carried out in said nozzle; and
in which the coated particles or a mixture of particles and of coating material or precursors of said material is/are recovered via said outlet.

14. Process according to claim 8, in which step (b) of bringing said synthesised particles into contact with the coating material or precursors thereof is carried out in said second reactor, this second reactor being a tube reactor comprising a first end equipped with an inlet and a second end equipped with an outlet;
in which, on the one hand, in a pressurized CO₂ medium, the particles synthesised in the first reactor and, on the other hand, at the same time a said particles, the coating material or precursors thereof, are injected into said second reactor via the inlet in such a way that the bringing into contact of the synthesised particles with the coating material or precursors thereof is carried out in said second reactor; and
in which the coated particles or a mixture of particles and of coating material or precursors of said material is/are recovered via said outlet.

15. Process according to claim 13, in which step (c) of coating the particles is carried out in said second reactor, subsequent to bringing the particles, in a pressurized CO₂ medium, into contact with the coating material or precursors thereof.

16. Process according to claim 13, in which step (c) of coating the particles is carried out at the outlet of said second reactor.

17. Process according to claim 13, in which a mixture of particles and of coating material or precursors thereof is recovered at the outlet of said second reactor, the coating step (c) being carried out in a reactor for recovering this mixture, connected to the outlet of said nozzle.

18. Process according to claim 8, in which the coated particles are recovered in at least one recovery reactor connected to the outlet of said second reactor.

19. Process according to claim 18, in which the coated particles are recovered in at least two recovery reactors connected to the outlet of said second reactor, said recovery reactors being used alternately or successively.

20. Process according to claim 1, in which the coating of the particles in coating step (c) is carried out by means of a process of precipitating the coating material on said particles.

21. Process according to claim 20, in which the precipitation process is chosen from an antisolvent process, an atomization process in a supercritical medium and a phase separation process.

22. Process according to claim 1, in which the coating of the particles in coating step (c) is carried out by chemical conversion of said precursors into said coating material in the presence of the particles to be coated.

23. Process according to claim 22, in which the chemical conversion is chosen from a polymerization, the precursors of the coating material being a monomer and/or a prepolymer of the coating material; a sol-gel synthesis; a thermal decomposition process; and an inorganic synthesis process.

24. Process according to claim 1, in which step (d) of recovering the coated particles comprises sweeping the coated particles with pressurized CO₂.

25. Process according to claim 1, in which step (d) of recovering the coated particles comprises expansion of the pressurized CO₂.

26. Process according to claim 1, in which the coated particles are recovered in a solvent or in a surfactant solution.

27. Process according to claim 1, in which the particles are chosen from metal particles; particles of metal oxide(s); ceramic particles; particles of a catalyst or of a mixture of catalysts; particles of a cosmetic product or of a mixture of cosmetic products; and particles of a pharmaceutical product or of a mixture of pharmaceutical products.

28. Process according to claim 1, in which the particles are chosen from particles of titanium dioxide, of silica, of doped or undoped zirconium oxide, of doped or undoped ceria, of alumina, of doped or undoped lanthanum oxides, or of magnesium oxide.

29. Process according to claim 1, in which the coating material is a material chosen from a sintering agent, a friction agent, an anti-wear agent, a plasticizer, a dispersant, a crosslinking agent, a metallizing agent, a metallic binder, an anti-corrosion agent and an anti-abrasion agent.

30. Process according to claim 1, in which the coating material is chosen from an organic polymer, a sugar, a polysaccharide, a metal, a metal alloy and a metal oxide.

31. Process according to claim 1, in which the coating material is a polymer chosen from poly(methyl methacrylate) and polyethylene glycol; a metal chosen from copper, palladium and platinum; or a metal oxide chosen from magnesium oxide and alumina.

32. Process according to claim 31, in which, since the coating material is a polymer, its precursor is a monomer or a prepolymer of said polymer.

33. Process according to claim 1, in which the coated particles are chosen from yttrium-doped zirconium oxide particles coated with poly(methyl methacrylate), metal oxide catalyst particles coated with a noble metal, such as Ti oxide particles coated with Pd or Pt, and titanium dioxide particles coated with a polymer.

34. Process according to claim 1, in which the coated particles recovered constitute a nanophase powder of at least one oxide.

35. Process according to claim 1, in which the pressurized CO₂ medium is a supercritical CO₂ medium.
